(19) United States
(12) Patent Application Publication
(10) Pub. No.: US 2018/0005055 A1
(43) Pub. Date: Jan. 4, 2018

(54) MOVING OBJECT DETECTION METHOD IN DYNAMIC SCENE USING MONOCULAR CAMERA

(71) Applicant: POSTECH ACADEMY-INDUSTRY FOUNDATION, Pohang-si (KR)

(72) Inventors: Hong JEONG, Pohang-si (KR); Jeong Mok HA, Busan-si (KR); Woo Yeol JUN, Seoul (KR)

(21) Appl. No.: 15/618,042

(22) Filed: Jun. 8, 2017

(30) Foreign Application Priority Data
Jul. 4, 2016 (KR) 10-2016-0084305

(51) Int. Cl. G06K 9/00; G06K 9/32; G06T 7/246; G06K 9/46; B60Q 9/00

(52) U.S. Cl. CPC G06K 9/00805; G06K 9/4671; B60Q 9/00; G06T 7/248; G06K 9/3208; G06T 2207/10016; G06T 2207/30261

(57) ABSTRACT

The present invention relates to a moving object detection method in a dynamic scene using a monocular camera, which is capable of detecting a moving object using a monocular camera installed on the moving object such as a vehicle, and warning a driver of a dangerous situation. The moving object detection method in a dynamic scene using a monocular camera can detect a moving object in a dynamic scene using the monocular camera without a stereo camera.

### BACKGROUND

### 1. Technical Field

The present disclosure relates to a moving object detection method in a dynamic scene using a monocular camera, and more particularly, to a method for detecting a moving object in a dynamic scene using a monocular camera

### 2. Related Art

An image contains data obtained by expressing light of the real world as numbers. If a camera is not moved, all of the numbers are not changed. Therefore, when objects of which the numbers are changed are detected and displayed, moving objects can be recognized. Such a scene in which a camera is not moved is referred to as a static scene. In general, the technique for detecting a moving object in a static scene is publicly known.

The technique for detecting a moving object in a static scene is based on the Gaussian mixture model. The technique divides an image into a predetermined size of grids, stores information of various frames in each of the grids, and compares the value of the information to the value of a new input image. When the values have different distributions, the technique detects the difference as a moving object. However, since this technique can be performed only in a scene where an image is not moved, the technique cannot be used for a method of detecting a moving object in a dynamic scene.

Furthermore, a method for detecting only vehicles and pedestrians regardless of the motions of objects has also been used. That is, the method is to detect all vehicles and pedestrians through a mechanical learning process for vehicle information and pedestrian information. This method exhibits excellent performance, but detects all objects regardless of whether the objects are moved or not. Thus, the method cannot select and notify only objects to which a driver needs to pay attention.

The conventional methods are based on the technique for detecting a moving object in a static scene where a camera is not moved, and thus have difficulties in detecting a moving object in a dynamic scene where a camera is moved.

### SUMMARY

Various embodiments are directed to a moving object detection method in a dynamic scene using a monocular camera, which is capable of extracting feature points from an image obtained through the monocular camera in a dynamic scene where the camera is moved, and applying an epipolar line constraint and an optical flow constraint, thereby detecting a moving object.

In an embodiment, a moving object detection method in a dynamic scene using a monocular camera may include: an image receiving step of receiving an image from a monocular camera; a feature point extraction step of receiving the image from the monocular camera, and extracting feature points of a moving object using the received image; a rotation compensation step of performing rotation compensation on the extracted feature points; an epipolar line constraint step of applying an epipolar line constraint; and an optical flow constraint step of applying an optical flow constraint.

According to the embodiment of the present invention, the moving object detection method in a dynamic scene using a monocular camera can detect a moving object in a dynamic scene using only the monocular camera, without using a stereo camera.

### BRIEF DESCRIPTION OF THE DRAWINGS

FIG. 1 is a flowchart of a moving object detection method in a dynamic scene using a monocular camera according to an embodiment of the present invention.

FIGS. 2A and 2B are photographs for describing a feature point extraction step in the moving object detection method in a dynamic scene using a monocular camera according to the embodiment of the present invention.

FIG. 3 is a photograph for describing a rotation compensation step in the moving object detection method in a dynamic scene using a monocular camera according to the embodiment of the present invention.

FIGS. 4A and 4B are photographs showing compensated feature points as a rotation compensation result in the moving object detection method in a dynamic scene using a monocular camera according to the embodiment of the present invention.

FIG. 5 is a diagram for describing an optical flow limitation in the moving object detection method in a dynamic scene using a monocular camera according to the embodiment of the present invention.

FIG. 6 is a photograph showing a moving object detection result of the moving object detection method in a dynamic scene using a monocular camera according to the embodiment of the present invention, compared to the conventional method.

FIG. 7 is a photograph showing a moving object detection result of the moving object detection method in a dynamic scene using a monocular camera according to the embodiment of the present invention, compared to the conventional method.

### DETAILED DESCRIPTION

Moving object detection (also referred to as ‘MOD’) refers to a technique for detecting an object which changes its position in consecutive images, and can be applied to the ADAS (Advanced Driver Assistance System) and smart car system.

In order to sense a moving object in an image and warn a driver of a dangerous situation such that the driver and pedestrians can be protected from a moving vehicle, an algorithm for detecting an object approaching the moving vehicle plays a very important role. At this time, the most difficult problem for the algorithm for detecting a moving object is to detect a moving object in a scene where a camera is being moved (referred to as ‘dynamic scene’).

The present invention relates to a technique for detecting a moving object in a dynamic scene using a monocular camera. The moving object detection technique uses two kinds of epipolar geometry information, that is, an epipolar line constraint and an optical flow constraint, in order to distinguish between a stationary object and a moving object when a camera is being moved.

First, in order to significantly reduce computer arithmetic operation, the moving object detection technique uses the epipolar line constraint between two consecutive frames.

When a camera is moved, the positions of all pixels in the image coordinate are changed. However, the position of an object in the world coordinate is irrelevant to the motion of the camera. Therefore, although the camera is being moved, a standing object is static.

This indicates that the pixels of a standing object (referred to as ‘background pixels’) remain on the epipolar line even though the camera is being moved, and the pixels of a moving object (referred to as ‘foreground pixels’) do not remain on the epipolar line.

However, when an object is moving along the epipolar line, the moving object cannot be sensed only by the epipolar line constraint. Thus, the optical flow constraint needs to be used in order to compensate for the epipolar line constraint.

The optical flow constraint is based on the supposition that two consecutive optical flows of a background pixel are equal to each other when the frame rate of a camera is sufficiently high. That is, the moving object detection technique compares two consecutive optical flows of a pixel, and identifies the pixel as a foreground pixel, that is, a pixel of a moving object when the two consecutive flows are different from each other.

Hereafter, embodiments of the present invention will be described with reference to the accompanying drawings such that this disclosure will be thorough and complete, and will fully convey the scope of the present invention to those skilled in the art. Throughout the drawings, like reference numerals represent the same components.

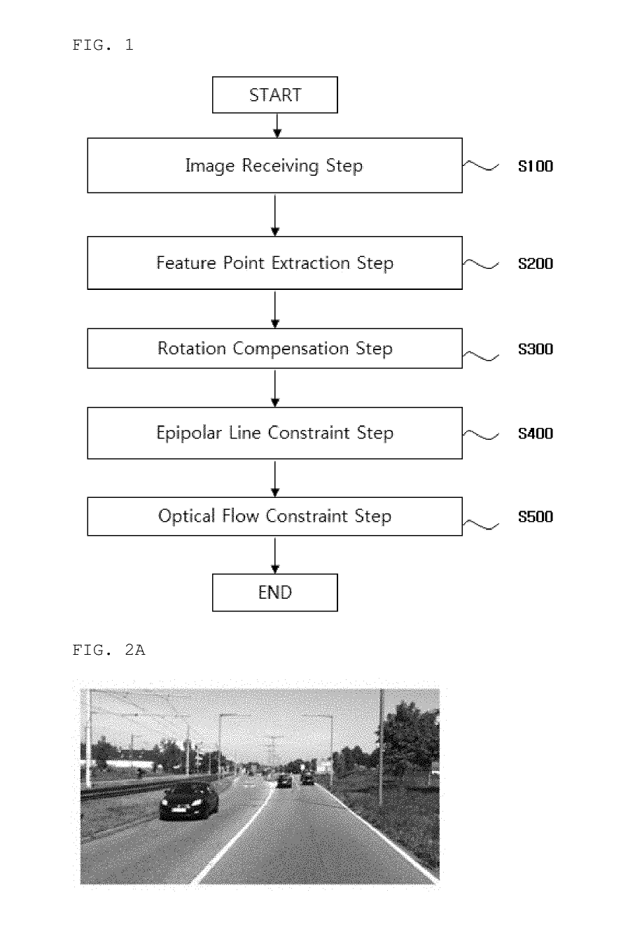

FIG. 1 is a flowchart of a moving object detection method in a dynamic scene using a monocular camera according to an embodiment of the present invention.

As shown in FIG. 1, the moving object detection method in a dynamic scene using a monocular camera according to the embodiment of the present invention includes an image receiving step S100, a feature point extraction step S200, a rotation compensation step S300, an epipolar line constraint step S400 and an optical flow constraint step S500.

The image receiving step S100 includes receiving an image from a monocular camera which is installed on a vehicle and moved by a motion of the vehicle.

The feature point extraction step S200 includes receiving an image from the monocular camera, and extracting feature points of a moving object using the received image. At the feature extraction step, the SIFT (Scale-Invariant Feature Transform) method is used to extract the feature points of three frames.

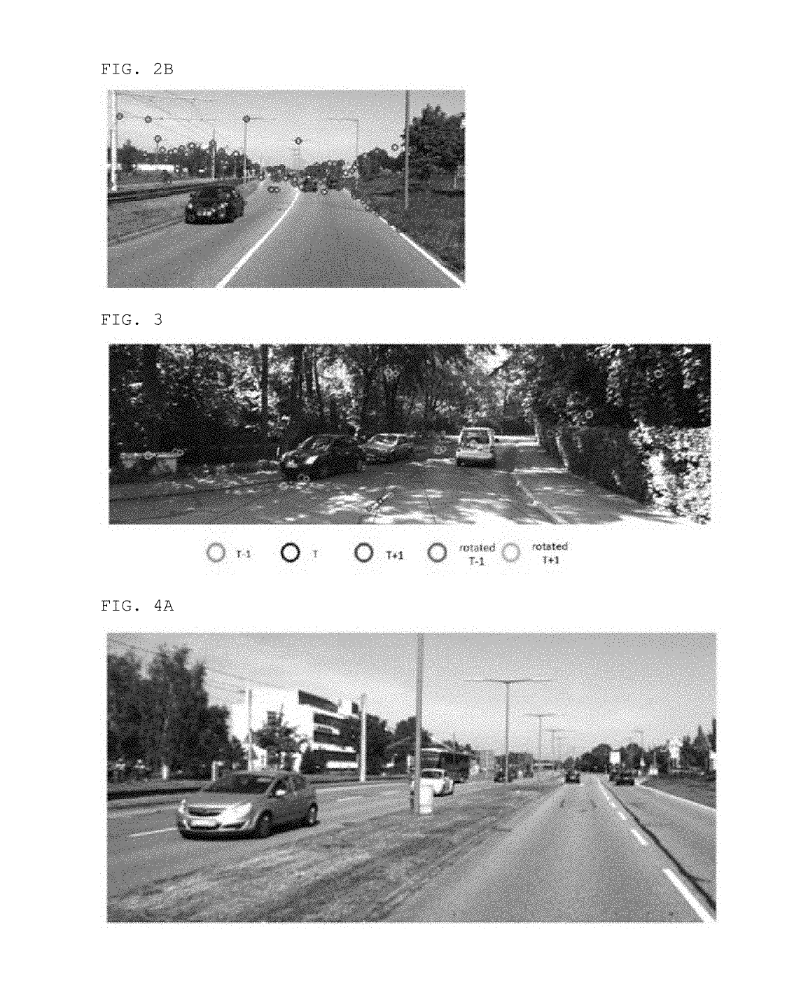

FIGS. 2A and 2B are photographs for describing the feature point extraction step in the moving object detection method in a dynamic scene using a monocular camera according to the embodiment of the present invention.

In the present embodiment, the SIFT method is used to extract the feature points of input frames. Furthermore, since the monocular camera is used instead of a stereo camera, the accurate positions of feature points in three frames need to be known. In such a situation, the SIFT method provides the accurate positions of feature points in three frames and a mismatching result. In FIG. 2B, red circles indicate extracted feature points.

The rotation compensation step S300 includes performing rotation compensation on the extracted feature points. Due to a road condition or a steering wheel operation of a driver, the camera may not be linearly moved, but rotated. Thus, a process of compensating for a rotation of the camera is needed. Since the rotation of the camera is very small, the rotation may be compensated for by a 5-parameter model. When the 5-parameter model for compensating for a rotation of the camera is implemented with the SIFT, the most efficient result can be obtained.

The purpose of the 5-parameter model is to not only position the matched feature points on an epipolar line calculated by the previously matched feature points when the rotation is compensated for, but also position the previously matched feature points on the epipolar line.

FIG. 3 is a photograph for describing the rotation compensation step in the moving object detection method in a dynamic scene using a monocular camera according to the embodiment of the present invention.

FIG. 3 shows that compensated feature points are shifted to the epipolar line (blue solid line), unlike feature points at t−1 and t+1.

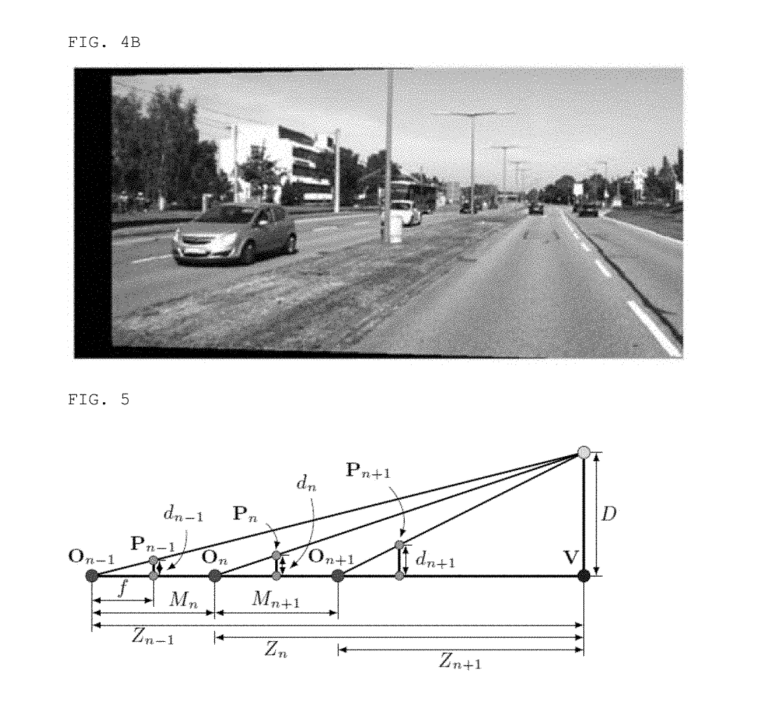

FIGS. 4A and 4B are photographs showing a rotation compensation result in the moving object detection method in a dynamic scene using a monocular camera according to the embodiment of the present invention.

FIG. 4A shows an input image, and FIG. 4B shows a rotated image as a compensation result through the 5-parameter model.

At the epipolar line constraint step S400 and the optical flow constraint step S500, an epipolar line constraint and an optical flow constraint of epipolar geometry information are applied.

The moving object detection method according to the present embodiment is to detect the position of a moving object in a dynamic scene. When a camera is installed on a vehicle, the camera is moved while the vehicle moves. Thus, when all pixels are moved, the moving object detection method needs to distinguish between background pixels (stationary objects) and foreground pixels (moving objects).

When the current frame is an n-th frame where n∈[0, . . . , N−1], a point of the world coordinate at the n-th frame may be represented by Pₙ=(X, Y, Z), and a pixel of the image coordinate at the n-th frame may be presented by pₙ.

If the camera is not moved, one point of the background in the world coordinate is projected onto the same pixel within the image coordinate. That is, (pₙ=pₙ₋₁). However, when the camera is moved, one point of the background in the world coordinate is projected onto pixels in the image coordinate. That is, (pₙ≢pₙ₋₁).

This is an important characteristic of the moving object detection (MOD) in a dynamic scene.

In the present embodiment, the epipolar line constraint is used to distinguish between a foreground pixel pₙ¹ and a background pixel p₀¹.

In Pₙ, the epipole is represented by eₙ, and the epipolar line is represented by lₙ.

The epipolar constraint indicates that, when the background is static, one pixel pₙ on the image plane Pₙ is always projected onto another pixel pₙ₋₁ on an epipolar line lₙ₋₁ at the image plane Pₙ₋₁.

Despite the motion of the camera, all pixels on the image plane Pₙ need to be projected onto the epipolar line at the image plane Pₙ₋₁, and vice versa.

However, a moving object in the world coordinate does not follow the epipolar line constraint. That is, a foreground pixel pₙ on the image plane Pₙ is not projected onto another pixel pₙ₋₁ on the epipolar line lₙ₋₁ at the image plane Pₙ₋₁, and vice versa.

Through this process, the foreground pixel may be distinguished from the background pixel.

However, when an object moves along the epipolar line, the foreground pixel pₙ on the image plane Pₙ is projected onto the epipolar line at the image plane Pₙ₋₁. In this case, three consecutive frames are used in order to check the moving object. This is based on the supposition that, when the image frame rate is sufficiently high, the distance of the object between the pixels pₙ and pₙ₋₁ is almost equal to the distance of the object between the pixels pₙ and pₙ₊₁.

In order to use two epipolar geometry constraints in consecutive frames, all epipoles need to be aligned with each other in the consecutive frames. When all epipoles need to be aligned with each other in consecutive frames, it may indicate that the epipoles of the three consecutive frames need to be equal to each other. The alignment of the epipoles needs to be completed before two epipolar geometry constraints are used.

Under to the supposition that all objects are static and only the camera installed on the vehicle is moved, only an ego-motion of the vehicle has an influence on the displacement of pixels. The ego-motion of the vehicle may be used to estimate an epipole and epipolar line in a dynamic scene.

Since an ego-motion in the world coordinate is projected onto an epipolar flow in the image coordinate, the epipolar flow may be estimated through consecutive frames for aligning the epipoles and epipolar lines.

The epipolar flow [u(p)=(u_{y}(p), uₓ(p))] of a pixel p includes a rotational flow u^{r}(p) and a translation flow u^{t}(p, d(p)).

That is, u(p)=u^{r}(p)+u^{t}(p, d(p)) (1)

In Equation 1, d(p) represents a distance from the camera to a pixel.

The rotational flow is related to a rotational component in the epipolar flow, and the translation flow is related to a distance component in the epipolar flow.

When the rotational flow is compensated for, the translation flow for the distance is projected along the epipolar line. Therefore, in order to align the epipoles of the n-th frame, (n−1)th frame and (n+1)th frame, the rotational flow needs to be estimated and compensated for.

In order to check different pixels in an image, SIFT characteristics in two consecutive frames are used to estimate a rotational flow.

When the SIFT characteristics are used, a stable result can be obtained, and only different background pixels for estimation may be used. When foreground pixels have an influence on the estimation of the rotational flow, the epipoles and the epipolar lines cannot be accurately estimated.

When the number of background pixels is much larger than the number of foreground pixels, the RANSAC (RANdom SAmple Consensus) may be used to remove the foreground pixels from the estimated rotational flow.

When the rotational flow is small, the rotational flow u^{r}(p) may be expressed as a function of [a=(a₁, a₂, a₃, a₄, a₅)^{T}], which has five components.

$${u}^{r} ( p ) = ( \begin{matrix}{a}_{1} - {a}_{3} \overline{y} + {a}_{4} {\overline{x}}^{2} + {a}_{5} \overline{x} \overline{y} \\ {a}_{2} + {a}_{3} \overline{x} + {a}_{4} \overline{x} \overline{y} + {a}_{5} {\overline{y}}^{2}\end{matrix} ) \qquad ( 2 )$$

In Equation 2, y̅=y−y_{c}, x̅=x−x_{c}, and x_{c} and y_{c} represent principle points of the x-axis and y-axis.

All components are related to the focal distance and the principle points. By using key points in an image, the component a may be calculated through the 8-point algorithm.

The 8-point algorithm is a method for obtaining geometry relationship information between two images. The geometry relationship between two images may be calculated through a rotational flow, and the information may be defined as [a=(a₁, a₂, a₃, a₄, a₅)^{T}]. In order to acquire this information, a minimum of 5 matching pairs is needed. A method using 5 matching pairs is referred to as the 5-point algorithm. However, since the 5-point algorithm has low stability, another algorithm such as 6-point algorithm or 7-point algorithm, which requires a larger number of matching points, may be applied. Currently, the 8-point algorithm is known as the most stable technique.

After the rotational flows between the n-th frame and the (n−1)th frame and between the n-th frame and the (n+1)th frame are calculated, the pixels on the image planes Pₙ₋₁ and Pₙ₊₁ are compensated for according to the image plane Pₙ. The epipoles and the epipolar lines on the three image planes become equal to each other after the compensation.

That is, e′ₙ₋₁=e′ₙ=e′ₙ₊₁, and l′ₙ₋₁=l′ₙ=l′ₙ₊₁. Here, e′ₙ and l′ₙ represent the epipole and epipolar line which are compensated for at the n-th frame.

Then, two epipolar geometry constraints may be applied in order to distinguish between the foreground pixels and the background pixels.

First, the epipolar line constraint will be described.

A first condition for distinguishing between background pixels and foreground pixels is to determine whether pixels are positioned on the epipolar line.

When pixels which are compensated for at the (n−1)th frame and the (n+1)th frame are represented by p′ₙ₋₁ and p′ₙ₊₁, the pixels p′ₙ₋₁ and p′ₙ₊₁ in the background pixels are necessarily positioned on the epipolar line lₙ(pₙ). However, the pixels p′ₙ₋₁ and p′ₙ₊₁ in the foreground pixels are not located on the epipolar line lₙ(pₙ).

These relationships may be expressed as follows.

lₙ(pₙ⁰)^{T}p′ₙ₋₁⁰=0 (3)

lₙ(pₙ⁰)^{T}p′ₙ₊₁⁰=0 (4)

lₙ(pₙ¹)^{T}p′ₙ₋₁¹≢0 (5)

lₙ(pₙ¹)^{T}p′ₙ₊₁¹≢0 (6)

These relationships are used to filter the foreground pixels.

Through the epipolar line at the n-th frame and the pixels which are compensated for at the (n−1)th frame and the (n+1)th frame, the background pixels and the foreground pixels may be distinguished from each other.

$$L ( p ) = \{ \begin{matrix}0 , & ‖ {{l}_{n} ( {p}_{n} )}^{⊤} {p}_{n - 1} ‖ \leq {λ}_{1} ⋂ ‖ {{l}_{n} ( {p}_{n} )}^{⊤} {p}_{n + 1} ‖ \leq {λ}_{1} \\ 1 , & otherwise\end{matrix} \qquad ( 7 )$$

In Equation 7, L(p) represents the estimated label of the pixel p, and λ₁ represents a threshold value which is applied to determine whether the pixel is positioned on the epipolar line.

When the estimated label L(p) is ‘0’, it may indicate that the pixel p is a background pixel, and when the estimated label L(p) is ‘1’, it may indicate that the pixel p is a foreground pixel.

Then, the optical flow constraint will be described.

When a moving object is not approaching a vehicle which is moving along the epipolar line, the moving object can be successfully checked through the epipolar line constraint. In this case, the foreground pixels move along the epipolar line.

In order to check the moving object in such a situation, the optical flows between the (n−1)th frame and the n-th frame and between the n-th frame and the (n+1)th frame need to be compared.

When the object is moving, the optical flows may be different from each other. On the other hand, when the object is not moving, the optical flows may be equal to each other.

In the world coordinate, the location of a static object is fixed. Thus, Pₙ₋₁=Pₙ=Pₙ₊₁.

As illustrated in FIG. 5, in the word line coordinate, Oₙ represents the position of the camera during the n-th frame, V represents the orthogonal point between P and a vanishing line, D represents a distance between V and P, Zₙ represents a distance between V and Oₙ, and Mₙ represents a distance between Oₙ and Oₙ₋₁.

In the image coordinate, f represents a focal distance, and dₙ represents a distance between the epipole eₙ and the pixel pₙ.

According to the trigonometry, the ratio of the (n−1)th frame, the n-th frame and the (n+1)th frame may be expressed by f, dₙ, D and Zₙ.

D: Zₙ₋₁=dₙ₋₁: ƒ (8)

D: Zₙ=dₙ: ƒ (9)

D: Zₙ₊₁=dₙ₊₁: ƒ (10)

At this time, when Zₙ₋₁ is substituted with Zₙ+Mₙ and Zₙ₊₁ is substituted with Zₙ−Mₙ₊₁, Equations 8 and 10 may be converted into (D: Zₙ+Mₙ=dₙ₋₁: f) and (D: Zₙ−Mₙ₊₁=dₙ₊₁: f), and expressed as Equation 11 which is a proportional expression with respect to Mₙ.

$$\frac{{M}_{n + 1}}{{M}_{n}} = \frac{{d}_{n - 1} ( {d}_{n + 1} - {d}_{n} )}{{d}_{n + 1} ( {d}_{n} - {d}_{n - 1} )} \qquad ( 11 )$$

When the frame rate is sufficiently high, the speed of the moving vehicle does not change between consecutive frames. Thus, Mₙ=Mₙ₊₁.

Therefore, Equation 11 for the background pixels needs to be ‘1’.

In order to distinguish between the foreground pixels and the background pixels using Equation 11, a conditional function of Equation 12 may be used.

$$L ( p ) = \{ \begin{matrix}0 , & \vert {d}_{n - 1} ( {d}_{n + 1} - {d}_{n} ) - {d}_{n + 1} ( {d}_{n} - {d}_{n - 1} ) \vert \leq {λ}_{2} \\ 1 , & otherwise\end{matrix} \qquad ( 12 )$$

In Equation 12, λ₂ represents the threshold value of the optical flow constraint.

That is, in order to apply two epipolar geometry constraints, Equations 7 and 12 are used.

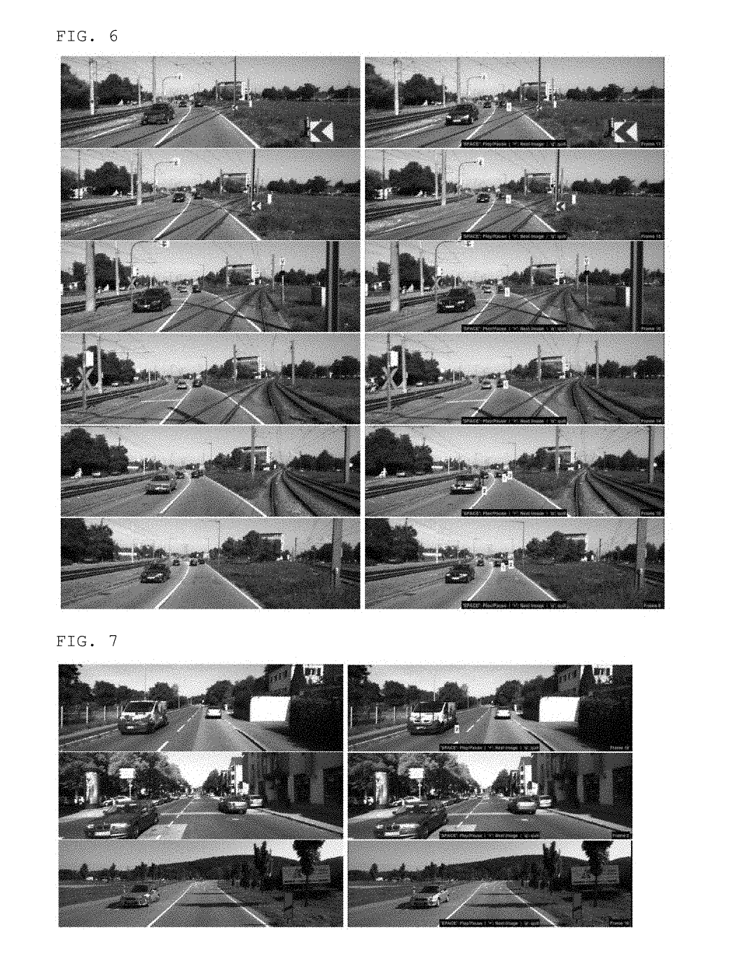

FIGS. 6 and 7 are photographs showing a moving object detection result of the moving object detection method in a dynamic scene using a monocular camera according to the embodiment of the present invention, compared to the conventional method.

The left columns of FIGS. 6 and 7 show that the moving object detection system in a dynamic scene using a monocular camera according to the present embodiment detected a vehicle which was approaching the vehicle having the camera mounted thereon.

However, when the vehicle approaching the vehicle having the camera mounted therein moves along the epipolar line, foreground pixels and background pixels are not easily distinguished from each other in the case that the epipolar line constraint is used. Therefore, in order to completely detect the moving object, the optical flow constraint as well as the epipolar line constraint needs to be used. A part of the images shows misdetected points, but such an error may occur due to a mismatch from the SIFT characteristic.

The right columns of FIGS. 6 and 7 show that the conventional moving object detection system did not completely detect a vehicle approaching the vehicle having the camera mounted thereon.

That is, in a dynamic scene where the camera is moved, the conventional moving object detection system may have difficulties in detecting a moving object even when a stereo camera provides depth information.

On the other hand, the moving object detection system in a dynamic scene using a monocular camera according to the present embodiment can detect an approaching object using data from only one camera under a situation where the camera is mounted on a moving vehicle.

When the vehicle having the camera mounted thereon is stopped and another vehicle is moving, both the conventional moving objection detection system and the moving object detection system in a dynamic scene using a monocular camera according to the present embodiment can detect a moving object. This indicates that detecting a moving object in a static scene is easier than detecting a moving object in a dynamic scene.

Furthermore, when the moving object detection method in a dynamic scene using a monocular camera according to the present embodiment detects a moving object, the time required for detecting the moving object can be shortened, compared to when the conventional moving object detection method detects a moving object. This is because the moving object detection method according to the present embodiment uses the monocular camera and requires only calculations for the SIFT, the rotational flow, the epipolar line constraint and the optical flow constraint.

When the vehicle having the camera mounted thereon is moved or stopped, the moving object detection system according to the present embodiment uses the rotational information from the steering system in the vehicle having the camera mounted thereon. Thus, the moving object detection system according to the present embodiment does not need to calculate the SIFT characteristic, the epipole or epipolar line, and can significantly reduce the arithmetic operation time.

While various embodiments have been described above, it will be understood to those skilled in the art that the embodiments described are by way of example only. Accordingly, the disclosure described herein should not be limited based on the described embodiments.

What is claimed is:

1. A moving object detection method in a dynamic scene using a monocular camera, comprising:
an image receiving step of receiving an image from a monocular camera;
a feature point extraction step of receiving the image from the monocular camera, and extracting feature points of a moving object using the received image;
a rotation compensation step of performing rotation compensation on the extracted feature points;
an epipolar line constraint step of applying an epipolar line constraint; and
an optical flow constraint step of applying an optical flow constraint.

2. The moving object detection method of claim 1, wherein the monocular camera is installed on a vehicle, and moved by a motion of the vehicle.

3. The moving object detection method of claim 1, wherein the feature point extraction step comprises extracting feature points of three frames.

4. The moving object detection method of claim 3, wherein the feature point extraction step comprises extracting the feature points of the three frames using SIFT (Scale Invariant Feature Transform).

5. The moving object detection method of claim 1, wherein the rotation compensation step is implemented with a 5-parameter model.

6. The moving object detection method of claim 5, wherein the 5-parameter model is acquired through any one of a 5-point algorithm, a 6-point algorithm, a 7-point algorithm and an 8-point algorithm.

7. The moving object detection method of claim 1, wherein the moving object detection method is applied to an ADAS (Advanced Driver Assistance System) or smart car system.

8. A moving object detection system in a dynamic scene using a monocular camera, comprising:
a monocular camera installed on a vehicle and moved by a motion of the vehicle;
an image receiving unit configured to receive an image from the monocular camera;
a feature point extraction unit configured to extract feature points of a moving object using the image received from the monocular camera;
a rotation compensation unit configured to perform rotation compensation on the extracted feature points;
an epipolar line constraint unit configured to apply an epipolar line constraint; and
an optical flow constraint unit configured to apply an optical flow constraint.
